(19) United States
(12) Patent Application Publication
(10) Pub. No.: US 2011/0207472 A1
(43) Pub. Date: Aug. 25, 2011

(54) METHOD AND SYSTEM FOR CELLULAR CLOCK-ASSISTED WIRELESS ACCESS POINT LOCATING

(76) Inventors: Charles Abraham, Los Gatos, CA (US); Mark Buer, Gilbert, AZ (US); David Garrett, Tustin, CA (US); Jeyhan Karaoguz, Irvine, CA (US); David Albert Lundgren, Mill Valley, CA (US); David Murray, Mission Viejo, CA (US)

(21) Appl. No.: 12/748,225

(22) Filed: Mar. 26, 2010

Related U.S. Application Data
(60) Provisional application No. 61/306,393, filed on Feb. 19, 2010.

(51) Int. Cl. H04W 64/00

(52) U.S. Cl. 455/456.1

(57) ABSTRACT

A wireless access point comprising a cellular receiver receives radio signals from a cellular base station. A cellular reference clock, synchronized to the cellular base station, is detected from the received radio signals. The detected cellular reference clock is utilized to stabilize a local access point clock for GNSS positioning. A clock difference between the local access point clock and the detected cellular reference clock is determined and the local access point clock may be adjusted accordingly. The adjusted local access point clock is utilized for clocking communications between the wireless access point and other communication devices. A time offset between the adjusted local access point clock and the detected cellular reference clock is provided to a remote location server. The remote location server retrieves time offset information from wireless access points served by the cellular base station so as to determine relative distances among the wireless access points.

### CROSS-REFERENCE TO RELATED APPLICATIONS/INCORPORATION BY REFERENCE

This patent application makes reference to, claims priority to and claims the benefit from U.S. Provisional Patent Application Ser. No. 61/306,393 filed on Feb. 19, 2010.

This patent application makes reference to:

U.S. Application Ser. No. 61/303,931 filed on Feb. 12, 2010,

U.S. Application Ser. No. 61/303,975 filed on Feb. 12, 2010,

U.S. application Ser. No. ______ (Attorney Docket No. 21013US02) filed on even date herewith, and

U.S. application Ser. No. ______ (Attorney Docket No. 21015US02) filed on even date herewith.

Each of the above stated applications is hereby incorporated herein by reference in its entirety.

### FIELD OF THE INVENTION

Certain embodiments of the invention relate to communication systems. More specifically, certain embodiments of the invention relate to method and system for cellular clock-assisted wireless access point locating.

### BACKGROUND OF THE INVENTION

Location-based services (LBS) are emerging as a new type of value-added service provided by mobile communication network. LBS are mobile services in which the user location information is used in order to enable various LBS applications such as, for example, enhanced 911 (E-911), location-based 411, location-based messaging and/or location-based friend finding services. A location of a communication device may be determined in different ways such as, for example, using network-based technology, using terminal-based technology, and/or hybrid technology, which is a combination of the former technologies. Many positioning technologies such as, for example, Time of Arrival (TOA), Observed Time Difference of Arrival (OTDOA), Enhanced Observed Time Difference (E-OTD) as well as the Global navigation satellite-based systems (GNSS) such as GPS, GLONASS, Galileo, and/or Assisted-GNSS (A-GNSS), may be utilized to estimate the location (latitude and longitude) of the communication device and convert it into a meaningful X, Y coordinate for LBS applications. A-GNSS technology combines satellite positioning and communication networks such as mobile networks to reach performance levels allowing the wide deployment of Location-Based Services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for cellular clock-assisted wireless access point locating, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to determine the location of a wireless access point using cellular clock information that is received by the wireless access point, in accordance with an embodiment of the invention.

FIG. 2 is a block diagram illustrating an exemplary wireless access point that is operable to stabilize a local access point clock utilizing cellular clock information received from a cellular base station, in accordance with an embodiment of the invention.

FIG. 3 is a block diagram illustrating an exemplary location server that is operable to derive location information of a wireless access point based on cellular clock information that is received by the wireless access points, in accordance with an embodiment of the invention.

FIG. 4 is a flow chart illustrating exemplary steps that are utilized by a wireless access point to stabilize a local access point clock based on received cellular clock information, in accordance with an embodiment of the invention.

FIG. 5 is a flow chart illustrating exemplary steps that are utilized by a location server to refine location information of wireless access points utilizing corresponding time offset information derived from a cellular reference clock, in accordance with an embodiment of the invention.

FIG. 6 is a flow chart illustrating exemplary steps that are utilized by a wireless access point to facilitate GNSS positioning based on received cellular clock information, in accordance with an embodiment of the invention.

### DETAILED DESCRIPTION OF THE INVENTION

Certain embodiments of the invention may be found in a method and system for cellular clock-assisted wireless access point locating. In various embodiments of the invention, a wireless access point, either a WiFi access point or a Bluetooth access point, that comprises a cellular receiver may be operable to receive radio signals from a cellular base station utilizing the cellular receiver. The wireless access point detects or captures a cellular reference clock from the received radio signals. The detected cellular reference clock is synchronized to the cellular base station. The wireless access point may utilize the detected cellular reference clock to stabilize a local access point clock to clock communications between the wireless access point and one or more communication devices and/or one or more network devices. Timing synchronization information associated with the detected cellular reference clock may be applied to facilitate GNSS positioning whenever needed. A clock difference between the local access point clock and the detected cellular reference clock may be determined and an adjustment may be made to the local access point clock based on the determined clock difference. For example, in instances where the determined clock difference is greater than a pre-determined threshold value, the local access point clock may be adjusted so as to limit the resulting clock difference so that it is less than the pre-determined threshold value. The adjusted local access point clock may be utilized to clock communications between the wireless access point and the one or more communication devices and/or one or more network devices. The one or more communication devices and/or one or more network devices may be part of a broadband communication network. A time offset between the adjusted local access point and the detected cellular reference clock may be calculated. The calculated time offset information may be communicated to a remote location server that is coupled with a reference database. The remote location server may be operable to retrieve or track time offset information from a plurality of wireless access points that are served by the cellular base station. The remote location server may be operable to utilize the retrieved time offset information to determine or calculate relative distances among the plurality of wireless access points. The calculated relative distances may be stored in the reference database and/or shared among communication devices and/or network devices.

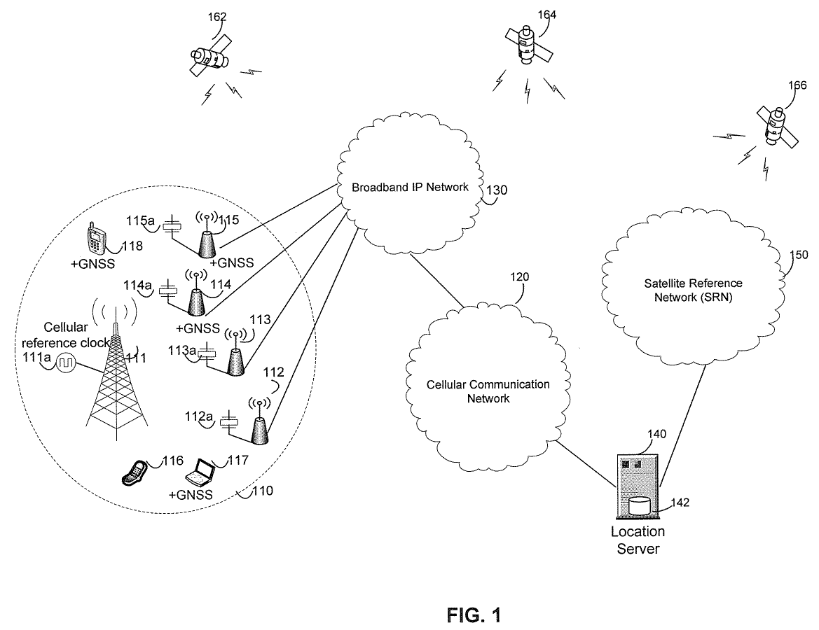

FIG. 1 is a diagram illustrating an exemplary communication system that is operable to determine the location of a wireless access point using cellular clock information that is received by the wireless access point, in accordance with an embodiment of the invention. Referring to FIG. 1, there is shown a communication system 100. The communication system 100 comprises a cell 110, a cellular communication network 120, a broadband IP network 130, a location server 140 comprising a reference database 142, a satellite reference network (SRN) 150 and a plurality of Global Navigation Satellite Systems (GNSS) satellites, of which GNSS satellites 162-166 are illustrated.

The cell 110 represents a geographical area, which is covered or served by a cellular base station 111. The cell 110 comprises the cellular base station 111 and a plurality of served communication devices of which, wireless access points 112-115 and mobile devices 116-118 are displayed. The cellular base station 111 may comprise suitable logic, circuitry, interfaces and/or code that are operable to manage various aspects of communication, for example, communication connection establishment, connection maintenance and/or connection termination, with associated devices such as the wireless access points 112-115 within the cell 110. The cellular base station 111 may be operable to manage radio resources such as, for example, radio bearer control, radio admission control, connection mobility control, and/or dynamic allocation of radio resources within the cell 110.

To ensure the quality of communication within the cell 110, the cellular base station 111 may be configured to synchronize to a cellular reference clock 111a, and transfer timing synchronization information provided by the captured cellular reference clock 111a to intended communication devices such as the wireless access points 112-115 and/or the mobile devices 116-118. In this regard, the captured cellular reference clock 111a may enable the intended communication devices to be synchronized to the cellular communication network 120 (the cellular reference clock 111a). The captured cellular reference clock 111a may facilitate to solve timing and/or frequency offset issues before data transmissions of desired services such as LBS applications may be initiated with the intended communication devices such as the wireless access points 112-115 and/or the mobile devices 116-118. In this regard, location information of the wireless access points 112-115 and/or the mobile devices 116-118 may be required to support the desired LBS applications. The cellular base station 111 may be operable to communicate with the location server 140 to acquire the locations of the wireless access points 112-115 and/or the mobile devices 116-118, which may be determined and/or refined by the location server 140 based on the timing synchronization information provided by the captured cellular reference clock 111a. Various air interface protocols specified in, for example, CDMA, GSM, UMTS, and/or LTE radio access networks may be utilized by the cellular base station 111 for communications within the cell 110.

Wireless access points such as the wireless access points 112-115 may comprise suitable logic, circuitry, interfaces and/or code that are operable to connect wireless communication devices to a wireless or wired network such as the broadband IP network 130 using Wi-Fi, Bluetooth or related standards. A wireless access point may be configured to function as a central transmitter and receiver of a wireless local network (WLAN). A specific local access point clock such as a lower-cost temperature-compensated oscillator (TCXO) may be utilized by the wireless access point for communications with the broadband IP network 130. For example, the local access point clocks 112a-115a may be utilized by the wireless access points 112-115, respectively, to provide clock information for corresponding communications with the broadband IP network 130. The local access point clocks 112a-115a may be communicatively coupled, internally or externally, to the wireless access points 112-115, respectively.

In various embodiments of the invention, a wireless access point such as the wireless access point 112 may be configured to receive radio signals from the cellular base station 111 but not to transmit radio signals to the cellular base station 111. Depending on device capabilities, the wireless access point 112 may be operable to receive radio signals from the cellular base station 111 utilizing, for example, CDMA, GSM, UMTS, and/or LTE access technologies. The received radio signals may comprise a cellular reference clock such as the cellular reference clock 111a that is utilized by the cellular base station 111 for communications within the cell 110. The wireless access point 112 may be operable to capture or detect the cellular reference clock 111a from the received cellular radio signals.

The wireless access point 112 may be operable to utilize the captured cellular reference clock 111a to stabilize or refine a local access point clock such as the local access point clock 112a that is utilized to clock data exchange or communications between the wireless access point 112 and the broadband IP network 130. For example, the wireless access point 112 may be operable to track clock difference between the local access point clock 112a and the captured cellular reference clock 111a. In instances where the clock difference is less than or equal to a pre-determined threshold value, the wireless access point 112 may be operable to utilize the local access point clock 112a to provide clock information for communications between the wireless access point 112 and the broadband IP network 130. In instances where the clock difference is greater than the pre-determined threshold value, the wireless access point 112 may be operable to adjust the local access point clock 112a so as to limit and/or reduce the clock difference between the adjusted local access point clock 112a and the captured cellular reference clock 111a so that it is less than the pre-determined threshold value. The adjusted local access point clock 112a may be utilized to provide clock information for subsequent communications between the wireless access point 112 and the broadband IP network 130.

In various embodiments of the invention, the wireless access point 112 may be operable to derive or calculate a time offset from the clock difference for the stabilized local access point clock 112a. The calculated time offset is proportional to a relative distance between the wireless access point 112 and the cellular base station 111. The wireless access point 112 may be operable to communicate the calculated time offset information to the location server 140 via the broadband IP network 130. The communicated time offset information may be utilized by the location server 140 to refine or determine location information of the wireless access point 112.

In various embodiments of the invention, the wireless access point 112 may be operable to utilize the timing synchronization information provided by the captured cellular reference clock 111a for GNSS positioning. For example, the timing synchronization information provided by the captured cellular reference clock 111a may be utilized to reduce sizes of time and/or frequency windows over which searches for GNSS signals may be conducted. In instances where GNSS assistance data such as reference positions and/or GNSS satellite ephemeris are received and utilized, the GNSS searches may be conducted with increased integration times yielding greater signal sensitivity by utilizing the reduced frequency and time search windows. The timing synchronization information provided by the captured cellular reference clock 111a may also allow the use of data wipeoff techniques wherein existing navigation data may be updated by the received assistance data. For example, known navigation data bit sequences may be removed or wiped off by known data bit sequences in the received assistance data. The updated navigation data may be applied for GNSS positioning at a precise time, based on the timing synchronization information provided by the captured cellular reference clock 111a. Depending on device capability, the timing synchronization information provided by the captured cellular reference clock 111a may be utilized for GNSS positioning by the wireless access point 112 and/or by one or more mobile devices such as the mobile devices 117-118 that are associated with the wireless access point 112. In this regard, in instances where the mobile devices 117-118 are GNSS capable, the wireless access point 112 may be operable to communicate or transmit the timing synchronization information provided by the captured cellular reference clock 111a to the mobile devices 117-118. The communicated timing synchronization information may be utilized or applied by the mobile devices 117-118 to facilitate corresponding GNSS positioning whenever needed.

Mobile devices such as the mobile devices 116-118 may comprise suitable logic, circuitry, interfaces and/or code that are operable to receive services provided by the broadband IP network 130 and/or the cellular communication network 120. For example, the mobile device 116 may be operable to access to the broadband IP network 130 via a wireless access point such as the wireless access point 112 utilizing, for example, Wi-Fi or Bluetooth technologies. In instances where a mobile device, for example, the mobile device 117, which is associated with the wireless access point 112, is GNSS capable, the mobile device 117 may be operable to receive timing synchronization information that is provided by the cellular reference clock 111a. The mobile device 117 may utilize the received timing synchronization information for GNSS positioning. For example, the mobile device 117 may apply GNSS measurements and/or GNS assistance data at a precise time, based on the received timing synchronization information that is provided by the cellular reference clock 111a. Depending on device capabilities, the mobile devices 116-118 may be operable to communicate with the cellular communication network 120 using, for example, CDMA, GSM, UMTS, LTE and WiMAX access technologies.

The mobile communication network 120 may comprise suitable logic, circuitry, interfaces and/or code that are operable to interface various access networks such as, for example, a CDMA network, a UMTS network and/or a LTE network, with external data networks such as packet data networks (PDNs) and/or the broadband IP network 130. The mobile communication network 120 may be configured to communicate various data services, which are provided by external data networks, to associated users such as, for example, the wireless access points 112-115 and/or the mobile devices 116-118. In instances where a LBS application is provided to a wireless device such as the wireless access point 112, the mobile communication network 120 may be operable to communicate with the location server 140 for corresponding location information required for the LBS application.

The broadband IP network 130 may comprise suitable logic, circuitry, interfaces and/or code that are operable to provide broadband IP connections to access the Internet and/or one or more carrier communication networks such as the mobile communication network 120. The broadband IP connections may comprise, for example, a digital subscriber line (DSL), a T1/E1 line, the cable television infrastructure, the satellite television infrastructure, and/or a satellite broadband internet connection.

The location server 140 may comprise suitable logic, circuitry, interfaces and/or code that are operable to access the satellite reference network (SRN) 150 to collect GNSS satellite data by tracking GNSS constellations through the SRN 150. The location server 140 may be operable to utilize the collected GNSS satellite data to generate GNSS assistance data (A-GNSS data) comprising, for example, ephemeris data, predicted ephemeris, namely, Long Term Orbit (LTO) data, reference positions and/or time information. The location server 140 may be operable to collect and/or retrieve location information from associated users such as the wireless access points 112-115 and/or the mobile devices 116-118 to update or refine the reference database 142. For example, the location server 140 may be operable to collect and/or receive time offset information with regard to the cellular reference clock 111a from the wireless access points 112-115 within the cell 110. With regard to a time offset received from, for example, the wireless access point 112, the location server 140 may be operable to utilize the received time offset to calculate or determine a relative distance between the wireless access point 112 and the cellular base station 111. With regard to time offsets received from, for example, the wireless access points 112-115, the location server 140 may be operable to determine or calculate relative distances between the wireless access points 112-115 based on the received time offsets. The calculated relative distances may be stored in the reference database 142 so that it may be shared among associated users such as the wireless access points 112-115. For example, the location server 140 may be operable to communicate the stored location information of the wireless access points 112-115 as A-GNSS data to the cellular base station 111 and/or other communication devices such as the wireless access points 112-115 and/or the mobile devices 116-118, whenever needed.

The SRN 150 may comprise suitable logic, circuitry, interfaces and/or code that are operable to collect and/or distribute data for GNSS satellites on a continuous basis. The SRN 150 may comprise a plurality of GNSS reference tracking stations located around the world to provide A-GNSS coverage all the time in both a home network and/or any visited network.

The GNSS satellites 162-166 may comprise suitable logic, circuitry, interfaces and/or code that may be operable to generate and broadcast satellite navigational information. The broadcast satellite navigational information may be collected by the SRN 150 to be utilized by the location server 140 to enhance LBS performance. The GNSS satellites 162-166 may comprise GPS, Galileo, and/or GLONASS satellites.

In an exemplary operation, a wireless access point such as the wireless access point 112 may be operable to communicate with the broadband IP network 130 utilizing the local access point clock 112. The wireless access point 112 may be allowed to receive radio signals from the cellular base station 111 that may synchronize to the cellular reference clock 111a. The wireless access point 112 may be operable to capture or detect the cellular reference clock 111a from the received radio signals. Timing synchronization information provided by the captured cellular reference clock 111a may be utilized for cellular signal reception. The wireless access point 112 may also be operable to utilize the timing synchronization information provided by the captured cellular reference clock 111a to stabilize or refine the local access point clock 112a that is utilized to clock communications between the wireless access point 112 and the broadband IP network 130. Clock difference between the local access point clock 112a and the captured cellular reference clock 111a may be monitored.

The local access point clock 112a may be adjusted to ensure that the clock difference is less than a pre-determined threshold value. A time offset corresponding to the clock difference may be calculated and may be communicated to the location server 140 via the broadband IP network 130. The location server 140 may be operable to retrieve time offset information with respect to the cellular reference clock 111a from the wireless access points 112-115. The collected time offset information may be converted to corresponding relative distances between the wireless access points 112-115 to refine location information within the reference database 142. The refined location information of the wireless access points 112-115 may be stored in the reference database 142 so that it may be shared among a plurality of communication and/or network devices. For example, the location server 140 may be operable to communicate the stored location information of the wireless access points 112-115 as A-GNSS data to users, when need. Depending on device capability, the wireless access points 112-115 may be operable to apply or utilize the timing synchronization information provided by the captured cellular reference clock 111a to facilitate GNSS positioning for its own and/or one or more corresponding associated GNSS capable mobile devices such as, for example, the mobile devices 117-118.

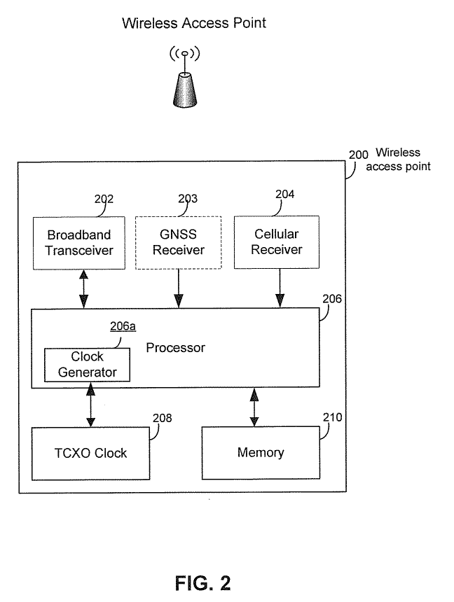

FIG. 2 is a block diagram illustrating an exemplary wireless access point that is operable to stabilize a local access point clock utilizing cellular clock information received from a cellular base station, in accordance with an embodiment of the invention. Referring to FIG. 2, there is shown a wireless access point 200. The wireless access point 200 comprises a broadband transceiver 202, a GNSS receiver 203, a cellular receiver 204, a processor 206, a clock generator 206a, a TXCO clock 208 and a memory 210.

The broadband transceiver 202 may comprise suitable logic, circuitry, interfaces and/or code that may be operable to transmit voice and/or data in adherence with one or more Internet protocol (IP) broadband standards. The broadband transceiver 202 may be operable to communicate voice and/or data with the broadband IP network 130 over a T1/E1 line, DSL, cable television infrastructure, satellite broadband internet connection, satellite television infrastructure, and/or Ethernet. The broadband transceiver 202 may also be operable to communicate services provided by the broadband IP network 130 to associated mobile devices such as the mobile devices 116-118. In this regard, timing synchronization information provided by a cellular reference clock such as the cellular reference clock 111a captured via the cellular receiver 204 may be communicated to the mobile devices 116-118 for GNSS positioning, for example, whenever needed.

The GNSS receiver 203 may comprise suitable logic, circuitry, interfaces and/or code that may be operable to detect and receive GNSS signals from a plurality of visible GNSS satellites such as the GNSS satellite 162-166. The GNSS receiver 203 may be operable to utilize the received GNSS signals to calculate navigation information such as a GNSS position of the GNSS receiver 203. In this regard, timing synchronization information provided by a cellular reference clock such as the cellular reference clock 111a may be utilized to facilitate GNSS positioning. The calculated GNSS position of the GNSS receiver 203 may be provided to the host processor 206 for various applications such as, for example, to location-based access control. Depending on device capability, the GNSS receiver 203 is optional for the wireless access point 200.

The cellular receiver 204 may comprise suitable logic, circuitry, interfaces and/or code that may be operable to receive radio signals from the cellular base station 111 utilizing various cellular access technologies such as CDMA, GSM, UMTS and/or LTE. The cellular receiver 204 may receive various data services such as LBS applications provided by the cellular communication network 120. The cellular receiver 204 may be operable to communicate the received radio signals from the cellular base station 111 to the processor 206 for further processing.

The processor 206 may comprise suitable logic, circuitry, interfaces and/or code that may be operable to manage and/or control operations of associated device component units such as the broadband transceiver 202, the cellular receiver 204, and the clock generator 206a depending on usages. For example, the processor 206 may be operable to activate or deactivate one or more associated radios such as the cellular receiver 204 as a needed basis to save power. The processor 206 may be operable to capture or detect a cellular reference clock such as the cellular reference clock 111a from radio signals received from the cellular base station 111 via the cellular receiver 204. The processor 206 may be operable to communicate timing synchronization information provided by the captured cellular reference clock 111a to the clock generator 206a to stabilize the TXCO clock 208.

The clock generator 206a may comprise suitable logic, circuitry, interfaces and/or code that may be operable to generate a local access point clock, which may be utilized for communicating with the broadband IP network 120. In this regard, the clock generator 206a may be operable to stabilize the TXCO clock 208 utilizing a cellular reference clock that is captured from received radio signals from the cellular base station 111. The processor 206 may be configured to track a clock difference between a local access point clock generated by the TXCO clock 208 and the captured cellular reference clock. In instances where the clock difference is less than a pre-determined threshold value, the clock generator 206a may be operable to utilize the generated local access point for communications between the broadband transceiver 202 and the broadband IP network 130. In instances where the clock difference is greater than the pre-determined threshold value, the clock generator 206a may be configured to adjust the TXCO clock 208 so as to limit the resulting clock difference between the adjusted local access point clock and the captured cellular reference clock so that it is less than the pre-determined threshold value. The processor 206 may be operable to utilize the adjusted local access point clock for communications between the broadband transceiver 202 and the broadband IP network 130. A time offset between the wireless access point 200 and the cellular base station 111 may be derived or calculated from the clock difference. The calculated time offset may be proportional to a relative distance between the wireless access point 200 and the cellular base station 111. The processor 206 may be operable to communicate the calculated time offset to the location server 140, where it may be utilized for refining location information that is stored in the reference database 142.

The memory 210 may comprise suitable logic, circuitry, interfaces and/or code that may be operable to store information such as executable instructions and data that may be utilized by the processor 206 and/or other associated device components such as, for example, the broadband transceiver 202 and the cellular receiver 204. The memory 210 may comprise RAM, ROM, low latency nonvolatile memory such as flash memory and/or other suitable electronic data storage.

In an exemplary operation, the processor 206 may be operable to activate the cellular receiver 204 for receiving radio signals via the cellular receiver 204 from the cellular base station 111. The processor 206 may capture or detect a cellular reference clock such as the cellular reference clock 111a from the received radio signals. The clock generator 206a may be operable to utilize timing synchronization information provided by the captured cellular reference clock 111a to stabilize the TXCO clock 208. In this regard, the clock generator 206a may be configured to track a clock difference between a local access point clock generated by the TXCO clock 208 and the captured cellular reference clock. The TXCO clock 208 may be adjusted to ensure that the clock difference is less than a pre-determined threshold value. The adjusted local access point clock may be utilized by the processor 206 for communications between the broadband transceiver 202 and the broadband IP network 130. The processor 206 may derive or calculate a time offset between the wireless access point 200 and the cellular base station 111 from the clock difference. The processor 206 may be configured to communicate the calculated time offset to the location server 140. The communicated time offset may provide information on a relative distance between the wireless access point 200 and the cellular base station 111 and may be utilized by the location server 140 to refine location information that is stored in the reference database 142. Depending on device capabilities, the processor 206 may be operable to apply or utilize the timing synchronization information provided by the captured cellular reference clock 111a to facilitate GNSS positioning via the GNSS receiver 203 and/or one or more associated GNSS capable mobile devices.

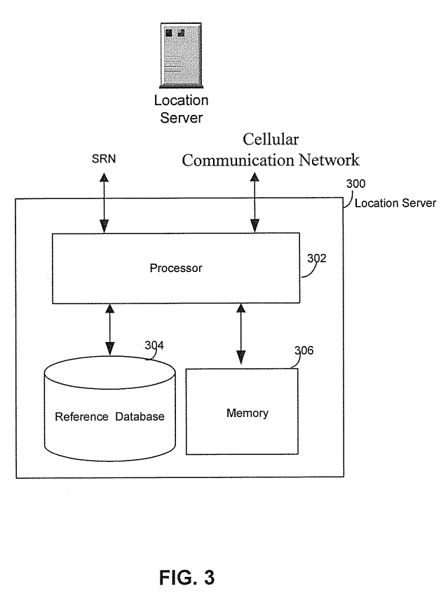

FIG. 3 is a block diagram illustrating an exemplary location server that is operable to derive location information of a wireless access point based on cellular clock information that is received by the wireless access points, in accordance with an embodiment of the invention. Referring to FIG. 3, there is shown a location server 300. The location server 300 may comprise a processor 302, a reference database 304 and a memory 306.

The processor 302 may comprise suitable logic, circuitry, interfaces and/or code that may be operable to manage and/or control operations of the reference database 304 and the memory 306. The processor 302 may be operable to communicate with the satellite reference network (SRN) 150 so as to collect GNSS satellite data by tracking GNSS constellations through the SRN 150. The processor 302 may utilize the collected GNSS satellite data to build the reference database 304, which may be coupled internally or externally to the location server 300. The processor 302 may be operable to retrieve or collect location information from associated users such as the wireless access points 112-115. The collected location information may comprise time offset information that is derived using corresponding local access point clocks and a cellular reference clock. Location information such as a relative distance between a wireless access point such as the wireless access point 112 and the cellular base station 111 may be determined or calculated based on a corresponding collected time offset. Relative distances between the wireless access point 112 with each of other wireless access points such as the wireless access points 112-115 within the cell 110 may be derived based on corresponding collected time offsets. The calculated relative distances may be stored into the reference database 304 to share among associated users. For example, the processor 302 may be operable to communicate at least a portion of the stored location information with, for example, the wireless access point 200 as a needed basis or periodically.

The reference database 304 may comprise suitable logic, circuitry, interfaces and/or code that may be operable to store location information of associated communication devices such as, for example, the wireless access points 112-115. The stored location information comprise relative distances between the wireless access points 112-115 and may be utilized to support LBS applications such as location-based access control. The location database 304 may be operable to manage and update the stored location information when need, aperiodically or periodically.

The memory 306 may comprise suitable logic, circuitry, interfaces and/or code that may be operable to store information such as executable instructions and data that may be utilized by the processor 302 and/or other associated component units such as, for example, the reference database 304. The memory 306 may comprise RAM, ROM, low latency nonvolatile memory such as flash memory and/or other suitable electronic data storage.

In an exemplary operation, the processor 302 may be operable to collect GNSS satellite data through the SRN 150 to build the reference database 304. The processor 302 may also be operable to collect or track location related information from a plurality of associated users such as the wireless access points 112-115 within the cell 110. The collected GNSS satellite data and/or location information may be utilized to build and/or update the reference database 304. In instances where the processor 302 receives time offset information that is calculated utilizing a cellular reference clock received from the cellular base station 111, the processor 302 may be operable to determine relative distances between wireless access points based on the corresponding received time offsets. The determined relative distances may be stored into the reference database 304 so that they may be shared among associated users such as the wireless access points 112-115.

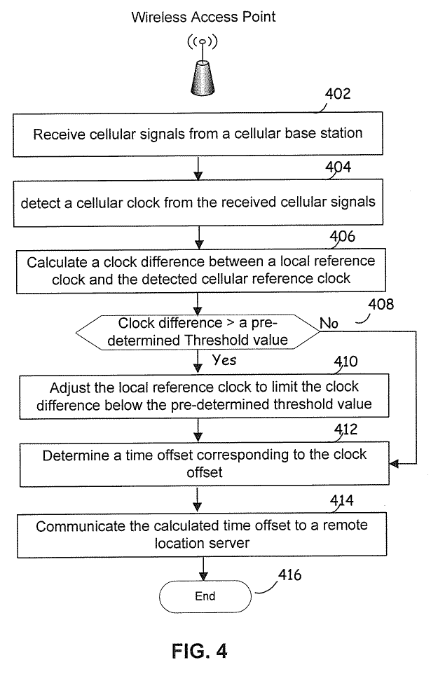

FIG. 4 is a flow chart illustrating exemplary steps that are utilized by a wireless access point to stabilize a local access point clock based on received cellular clock information, in accordance with an embodiment of the invention. Referring to FIG. 4, the exemplary steps may start with step 402. In step 402, a wireless access point such as the wireless access point 200, which is located in the cell 110, may be operable to receive cellular radio signals from a cellular base station such as the cellular base station 111 via the cellular receiver 204. The received radio signals may be communicated to the processor 206. In step 404, the processor 206 may be operable to capture or recover a cellular reference clock, to which the cellular base station 111 may synchronize, from the received radio signals. In step 406, the processor 206 may be operable to communicate the detected cellular reference clock to the clock generator 206a. A clock difference between a local access point clock that is generated by the TXCO clock 208 and the detected cellular reference clock may be calculated. In step 408, it may be determined whether the calculated clock difference is greater than a pre-determined threshold value. In instances where the calculated clock difference is greater than the pre-determined threshold value, then in step 410, the clock generator 206a may communicate with the TXCO clock 208 such that the TXCO clock 208 may be adjusted so that the clock difference is less than the pre-determined threshold value. The resulting local access point clock generated by the adjusted TXCO clock 208 may be utilized to provide clock information for communications between the broadband transceiver 202 and the broadband IP network 130. In step 412, the processor 206 may be operable to derive or calculate a time offset corresponding to the adjusted clock difference. The calculated time offset is proportional to a relative distance between the wireless access point 200 and the cellular base station 111. In step 414, the processor 206 may be operable to communicate the calculated time offset to a remote location server such as the location server 300. The exemplary steps may end in step 416.

In step 408, in instances where the calculated clock difference is less than or equal to the pre-determined threshold value, the exemplary steps may continue to step 412.

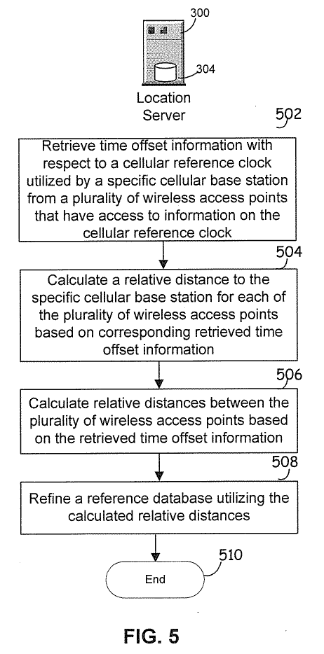

FIG. 5 is a flow chart illustrating exemplary steps that are utilized by a location server to refine location information of wireless access points utilizing corresponding time offset information that is derived from a cellular reference clock, in accordance with an embodiment of the invention. Referring to FIG. 5, the exemplary steps may start with step 502. In step 502, the location server 300 may be operable to retrieve or collect time offset information with respect to a cellular reference clock from a plurality of wireless access points such as the wireless access point 112-115. The wireless access points 112-115 may have access to information on the cellular reference clock 111a that is utilized by a specific cellular base station such as the cellular base station 111 for corresponding communications. In step 504, the processor 302 may be operable to calculate a relative distance to the cellular base station 111 for each of the wireless access point 112-115 based on corresponding time offset information retrieved. In step 506, the processor 302 may be operable to calculate relative distances among the wireless access points 112-115 based on the retrieved time offset information. In step 508, the processor 302 may be operable to communicate the calculated relative distances to the reference database 304 to refine corresponding location information within the reference database 304. The exemplary steps may end in step 510.

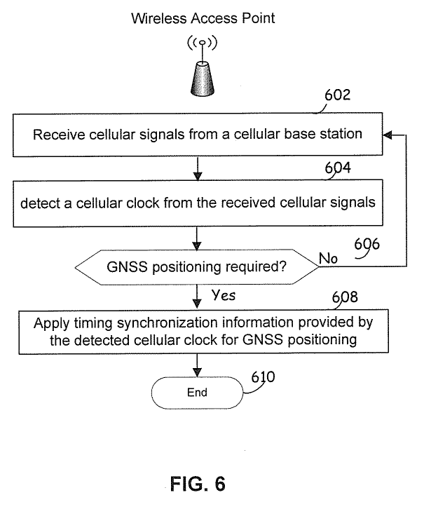

FIG. 6 is a flow chart illustrating exemplary steps that are utilized by a wireless access point to facilitate GNSS positioning based on received cellular clock information, in accordance with an embodiment of the invention. Referring to FIG. 6, the exemplary steps may start with step 602. In step 602, a wireless access point such as the wireless access point 200, which is located in the cell 110, may be operable to receive cellular radio signals from a cellular base station such as the cellular base station 111 via the cellular receiver 204. The received radio signals may be communicated to the processor 206. In step 604, the processor 206 may be operable to capture or recover a cellular reference clock, to which the cellular base station 111 may synchronize, from the received radio signals. In step 606, it may be determined whether a GNSS positioning is required by the wireless access point 200 and/or one or more associated GNSS capable mobile devices such as the mobile devices 117-118. In instances where a GNSS positioning is required, then in step 608. In step 608, timing synchronization information provided by the detected cellular clock may be applied for GNSS positioning. In this regard, in instances where GNSS positioning occurs on the mobile devices 117-118, the processor 206 may be operable to communicate the timing synchronization information provided by the detected cellular clock to the mobile devices 117-118 to facilitate corresponding GNSS positioning. The exemplary steps may end in step 610.

In step 606, in instances where a GNSS positioning is not required, the exemplary steps may return to in step 602.

In various exemplary aspects of the method and system for cellular clock-assisted wireless access point locating, a wireless access point such as the wireless access point 200 that comprises a cellular receiver 204 may be operable to receive cellular radio access signals from the cellular base station 111 utilizing the cellular receiver 204. The processor 206 of the wireless access point 200 may be operable to detect or capture a cellular reference clock such as the cellular reference clock 111a from the received radio signals. The detected cellular reference clock 111a may be synchronized to the cellular base station 111. The processor 206 may be operable to communicate the detected cellular reference clock 111a to the clock generator 206a to stabilize a local access point clock such as the local access point clock 112a, which may be generated by the TXCO clock 208. The generated local access point clock 112a is utilized to clock data transmissions or communications between the wireless access point 200 and one or more communication devices and/or one or more network devices. The one or more communication devices and/or one or more network devices may be part of a broadband communication network such as the broadband IP network 130. The timing synchronization information associated with the generated local access point clock 112a may also be applied to facilitate GNSS positioning on the wireless access point 200 and/or one or more associated GNSS capable mobile devices such as the mobile devices 117-118.

The wireless access point 200 may be implemented utilizing WiFi and/or Bluetooth technologies. A clock difference between the local access point clock 112a and the detected cellular reference clock 111a may be determined or calculated. The local access point clock 112a may be adjusted based on the determined clock difference when needed. For example, in instances where the determined clock difference is greater than a pre-determined threshold value, the local access point 112a may be adjusted to limit the resulting clock difference so that it is less than the pre-determined threshold value. The adjusted local access point clock 112a may be utilized by the wireless access point 200 to clock data transmissions or communications between the wireless access point 200 and one or more communication devices and/or one or more network devices that may be within, for example, the broadband IP network 130 or another network. A time offset between the adjusted local access point 112a and the detected cellular reference clock 111a may be calculated. As described with respect to FIG. 4 and FIG. 5, the calculated time offset information may be communicated to a remote location server such as the location server 300. The location server 300 may be operable to retrieve or collect time offset information from a plurality of wireless access points such as the wireless access points 112-115 that are served by the cellular base station 111. The location server 300 may be operable to utilize the retrieved time offset information to determine or calculate relative distances between the wireless access points 112-115 and/or the cellular base station 111. The calculated relative distances may be stored into the reference database 304 and/or may be shared among associated users.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for cellular clock-assisted wireless access point locating.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a wireless access point that comprises a cellular receiver:
receiving by said cellular receiver, radio signals from a cellular base station;
detecting a cellular reference clock from said received radio signals, wherein said detected cellular reference clock is synchronized to said cellular base station; and
utilizing said detected cellular reference clock to stabilize a local access point clock for said wireless access point to facilitate Global Navigation Satellite Systems (GNSS) positioning.

2. The method according to claim 1, wherein said GNSS positioning occurs on said wireless access point and/or on or more mobile devices associated with said wireless access point.

3. The method according to claim 1, comprising determining a clock difference between said local access point clock and said detected cellular reference clock.

4. The method according to claim 3, comprising adjusting said local access point clock based on said determined clock difference.

5. The method according to claim 4, comprising utilizing said adjusted local access point clock for communications between said wireless access point and one or more communication devices and/or network devices.

6. The method according to claim 5, comprising calculating a time offset between said adjusted local access point clock and said detected cellular reference clock.

7. The method according to claim 6, comprising communicating said calculated time offset to a remote location server.

8. The method according to claim 7, wherein said remote location server retrieves time offset information from a plurality of wireless access points served by said cellular base station.

9. The method according to claim 8, wherein said remote location server determines relative distances between said plurality of wireless access points and said cellular base station based on said retrieved time offset information.

10. The method according to claim 8, wherein said remote location server determines relative distances among said plurality of wireless access points based on said retrieved time offset information.

11. A system for communication, the system comprising:
one or more processors and/or circuits for use in a wireless access point that comprises a cellular receiver, said one or more processor being operable to:
receive by said cellular receiver, radio signals from a cellular base station;
detect a cellular reference clock from said received radio signals, wherein said detected cellular reference clock is synchronized to said cellular base station; and
stabilize, by said detected cellular reference clock, a local access point clock to facilitate Global Navigation Satellite Systems (GNSS) positioning.

12. The system according to claim 11, wherein said GNSS positioning occurs on said wireless access point and/or on or more mobile devices associated with said wireless access point.

13. The system according to claim 11, wherein said one or more processors and/or circuits are operable to determine a clock difference between said local access point clock and said detected cellular reference clock.

14. The system according to claim 13, wherein said one or more processors and/or circuits are operable to adjust said local access point clock based on said determined clock difference.

15. The system according to claim 14, wherein said one or more processors and/or circuits are operable to utilize said adjusted local access point clock for communications between said wireless access point and one or more communication devices and/or network devices.

16. The system according to claim 15, wherein said one or more processors and/or circuits are operable to calculate a time offset between said adjusted local access point clock and said detected cellular reference clock.

17. The system according to claim 16, wherein said one or more processors and/or circuits are operable to communicate said calculated time offset to a remote location server.

18. The system according to claim 17, wherein said remote location server retrieves time offset information from a plurality of wireless access points served by said cellular base station.

19. The system according to claim 18, wherein said remote location server determines relative distances between said plurality of wireless access points and said cellular base station based on said retrieved time offset information.

20. The system according to claim 18, wherein said remote location server determines relative distances among said plurality of wireless access points based on said retrieved time offset information.
